(19) United States
(12) Patent Application Publication
(10) Pub. No.: US 2026/0095498 A1
(43) Pub. Date: Apr. 2, 2026

(54) METHOD AND MCDATA NETWORK FOR HANDLING NON-MANDATORY DOWNLOAD FOR FD OVER MEDIA PLANE IN NETWORK

(71) Applicant: Samsung Electronics Co., Ltd., Suwon-si (KR)

(72) Inventors: Kiran Gurudev KAPALE, Bangalore (IN); Arunprasath RAMAMOORTHY, Bangalore (IN); Basavaraj Jayawant PATTAN, Bangalore (IN)

(21) Appl. No.: 19/410,764

(22) Filed: Dec. 5, 2025

Related U.S. Application Data
(63) Continuation of application No. 18/294,353.

(30) Foreign Application Priority Data
Aug. 11, 2021 (IN) 202141036395
Aug. 2, 2022 (IN) 2021 41036395

(51) Int. Cl. H04L 67/06; H04L 67/12

(52) U.S. Cl. CPC H04L 67/06; H04L 67/12

(57) ABSTRACT

The disclosure relates to a 5G or 6G communication system for supporting a higher data transmission rate. Embodiments herein provide a method for handling non-mandatory download procedure for FD over a media plane in a MCData network (1000) by at least one terminating MCData client device (300). The method includes receiving a MCData FD request comprising a non-mandatory download indication for file download from a MCData server (200). Further, the method includes generating the user consent for the file download.

### CROSS-REFERENCE TO RELATED APPLICATION(S)

This application is a continuation application of prior application Ser. No. 18/294,353, filed on Feb. 1, 2024, which is a U.S. National Stage application under 35 U.S.C. § 371 of an International application number PCT/KR2022/012003, filed on Aug. 11, 2022, which is based on and claims priority of an Indian Patent Application number 202141036395, filed on Aug. 2, 2022, in the Indian Patent Office, and of an Indian Patent Application number 202141036395, filed on Aug. 11, 2021, in the Indian Patent Office, the entire disclosure of each of which is incorporated by reference herein in its entirety.

### TECHNICAL FIELD

The present disclosure relates to manage a non-mandatory download procedure of a File Distribution (FD) using a media plane with additional functionalities support such as auto-receive of distributed file, generating and sending of the disposition notifications of user actions and file download complete indication, and to enable a later delivery of the FD request (i.e. group communication or 1-1 communication) with file content in mission critical services as specified in 3^{rd} Generation Partnership Project Technical Specification (3GPP TS) 23.282 architecture specification.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

A File Distribution (FD) service provides flexibility to a Mission Critical Data (MCData) user to choose an option for sending of a file to be delivered at a receiving MCData user or a MCData group as a mandatory download or non-mandatory download based on the situation and need. The existing specification provides such procedure from an originating MCData user to choose an option for sending of a file to be delivered at the receiving MCData user or the MCData group but no procedure exists for the terminating MCData user(s) to download or receive a shared file for non-mandatory file download option.

Sometimes, there is need for the file to be downloaded automatically (i.e. auto-receive) even if the received FD request indicates for non-mandatory download of the file but no procedures are defined for a MCData server in the current specification for the FD using media plane procedures for non-mandatory download indications. Similarly, the MCData server to store the FD request (i.e. group communication or 1-1 communication) with file content for the later delivery to enable the loss less communication or store and forward function that is required in case of specific group, user, or need basis etc is also not specified in the current specification. The FD request with non-mandatory download indication procedure also requires the MCData server or receiving MCData client to generate and send the receiving MCData user action to the MCData user at MCData client that requested for the file distribution and updating about the file download completion status to the sender if requested for it. Such procedures and capabilities are very critical for the public safety agencies and the mission critical (MC) operations. There are numerous ways to fulfil the desired procedures and capabilities.

Thus, it is desired to address the above mentioned disadvantages or other shortcomings or at least provide a useful alternative.

### DISCLOSURE

### Technical Problem

The principal object of the embodiments herein is to provide a method and a MCData network for handling non-mandatory download for file distribution (FD) over a media plane in the MCData network

Another object of the embodiments herein is to support a download of a file over the media plane when non-mandatory file download indication is included in a FD request.

Another object of the embodiments herein is to provide a MCData server to include a mandatory download indication while sending the FD request to a receiving MCData user if an auto-receive configuration is enabled for a file download.

Another object of the embodiments herein is to provide the MCData server or a receiving MCData client to generate and send a receiving MCData user action to an MCData user that requested for the file distribution.

Another object of the embodiments herein is to provide the MCData server to store the FD request with the file content for a later delivery in mission critical services for group communication or 1-1 communication.

### Technical Solution

Accordingly, the embodiment herein is to provide a method for handling non-mandatory download procedure for FD over a media plane in a Mission Critical Data (MCData) network. The method includes receiving, by a MCData server, a MCData FD request comprising a non-mandatory download indication for a file download from an originating MCData client device. Further, the method includes determining, by the MCData server, whether at least one of auto-receive configuration is enabled for the file download at the MCData server and a file download criteria is met. In an embodiment, the method includes receiving user consent for the file download from at least one terminating MCData client device of a plurality of the terminating MCData client devices, and sending a MCData FD response to the originating MCData client device based on the received user consent from the at least one terminating MCData client device in response to determining that the auto-receive configuration is not enabled and the file download criteria is met. The user consent indicates one of MCData user accepted the request for the file download, the MCData user declined the request for the file download, and the MCData user deferred the request for the file download. In another embodiment, the method includes converting the non-mandatory download indication to a mandatory download indication, sending a MCData FD request comprising the mandatory download to at least one terminating MCData client device of the plurality of the terminating MCData client devices, and sending a MCData FD response to the originating MCData client device based on the received user consent from the at least one terminating MCData client device in response to determining that the auto-receive configuration is enabled and the file download criteria is met. The user consent indicates MCData user accepted the request for the file download. In another embodiment, the method includes sending a MCData FD response to the originating MCData client device, receiving the file distributed over the media plane from the originating MCData client device, and storing the file for later deliver as the file download criteria for at least one terminating MCData client device of the plurality of at least one terminating MCData client devices is not met in response to determining that the file download criteria is not met irrespective of the auto-receive configuration is enabled or disabled.

In an embodiment, receiving the user consent for the file download from at least one terminating MCData client device from the plurality of the terminating MCData client devices includes one of sending by the MCData server the MCData FD request comprising the non-mandatory download indication for the file download to the at least one terminating MCData client device of the plurality of the terminating MCData client devices, and receiving by the MCData server a MCData FD response comprising the user consent from the at least one terminating MCData client device of the plurality of the terminating MCData client devices, and sending by the MCData server the MCData FD request comprising the non-mandatory download indication for the file download to the at least one terminating MCData client device of the plurality of the terminating MCData client devices, receiving by the MCData server a MCData FD response from the at least one terminating MCData client device of the plurality of the terminating MCData client devices, and receiving by the MCData server a FD disposition notification comprising the user consent from the at least one terminating MCData client device of the plurality of the terminating MCData client devices.

In an embodiment, sending the MCData FD response to the originating MCData client device based on the user consent includes one of sending by the MCData server the MCData FD response comprising the received user consent from the at least one terminating MCData client device to the originating MCData client device, and determining by the MCData server that the received consent indicates that the MCData user of the at least one terminating MCData client device of the plurality of terminating MCData client devices accepts the request for the file download, sending by the MCData server the MCData FD response indicating that the MCData user of the at least one terminating MCData client device of the plurality of terminating MCData client devices accepts the request for the file download, and sending by the MCData server a FD disposition notification to the originating MCData client device, wherein the FD disposition notification comprising information about the at least one terminating MCData client device of the plurality of terminating MCData client devices and the corresponding received consent for the file download.

In an embodiment, the method includes receiving, by the MCData server, the file distributed over the media plane from the originating MCData client device. Further, the method includes determining, by the MCData server, terminating MCData client devices of the plurality of MCData client devices for which the received user consent indicates that MCData user accepted the request for the file download. Further, the method includes sending, by the MCData server, the file distributed over the media plane to the terminating MCData client devices for which the received user consent indicates that MCData user accepted the request for the file download.

In an embodiment, the method includes receiving, by the MCData server, a MCData download completed report from the at least one terminating MCData client device. Further, the method includes sending, by the MCData server, the MCData download completed report to the originating MCData client device.

In an embodiment, the method includes receiving, by the MCData server, the file distributed over the media plane from the originating MCData client device. Further, the method includes determining, by the MCData server, terminating MCData client devices of the plurality of MCData client devices for which the received user consent indicates that MCData user deferred the request for the file download. Further, the method includes storing, by the MCData server, the file for later deliver for the terminating MCData client devices for which the received user consent indicates that MCData user deferred the request for the file download. Further, the method includes receiving, by the MCData server, a deferred FD list request from the terminating MCData client devices. Further, the method includes sending, by the MCData server, a deferred FD list response to the terminating MCData client devices. Further, the method includes receiving, by the MCData server, a file download request from the terminating MCData client devices. Further, the method includes sending, by the MCData server, a file download response to the terminating MCData client devices.

Accordingly, the embodiment herein is to provide a MCData network server for handling non-mandatory download procedure for FD over a media plane in a MCData network. The MCData server includes a non-mandatory download procedure controller communicatively coupled to a memory and a processor. The non-mandatory download procedure controller is configured to receive a MCData FD request comprising a non-mandatory download indication for a file download from an originating MCData client device. Further, the non-mandatory download procedure controller is configured to determine whether at least one of auto-receive configuration is enabled for the file download at the MCData server and a file download criteria is met. In an embodiment, the non-mandatory download procedure controller is configured to receive user consent for the file download from at least one terminating MCData client device of a plurality of the terminating MCData client devices, and send a MCData FD response to the originating MCData client device based on the received user consent from the at least one terminating MCData client device in response to determining that the auto-receive configuration is not enabled and the file download criteria is met. The user consent indicates one of MCData user accepted the request for the file download, the MCData user declined the request for the file download, and the MCData user deferred the request for the file download. In another embodiment, the non-mandatory download procedure controller is configured to convert the non-mandatory download indication to a mandatory download indication, send a MCData FD request comprising the mandatory download to at least one terminating MCData client device of the plurality of the terminating MCData client devices, and send a MCData FD response to the originating MCData client device based on the received user consent from the at least one terminating MCData client device in response to determining that the auto-receive configuration is enabled and the file download criteria is met. The user consent indicates MCData user accepted the request for the file download. In another embodiment, the non-mandatory download procedure controller is configured to send a MCData FD response to the originating MCData client device, receive the file distributed over the media plane from the originating MCData client device, and store the file for later deliver as the file download criteria for at least one terminating MCData client device of the plurality of at least one terminating MCData client devices is not met in response to determining that the file download criteria is not met irrespective of the auto-receive configuration is enabled or disabled.

Accordingly, the embodiment herein is to provide a method for handling non-mandatory download procedure for FD over a media plane in a MCData network. The method includes receiving, by at least one terminating MCData client device of the plurality of the terminating MCData client devices, a MCData FD request comprising a non-mandatory download indication for file download from a MCData server. Further, the method includes generating, by the at least one terminating MCData client device, a user consent for the file download. The user consent indicates one of MCData user accepted the request for the file download, the MCData user declined the request for the file download, and the MCData user deferred the request for the file download. Further, the method includes performing, by the at least one terminating MCData client device, one of sending a MCData FD response comprising the user consent to the MCData server, or sending a MCData FD response to the MCData server and sending a FD disposition notification comprising the user consent to the MCData server.

In an embodiment, the method includes receiving, by the at least one terminating MCData client device, file distributed over the media plane from the MCData server. Further, the method includes sending, by the at least one terminating MCData client device, a download completed report to the MCData server.

In an embodiment, the method includes sending, by the at least one terminating MCData client device, a deferred FD list request to the MCData server. Further, the method includes receiving, by the at least one terminating MCData client device, a deferred FD list response from the MCData server. Further, the method includes sending, by the at least one terminating MCData client device, a file download request to the MCData server. Further, the method includes receiving, by the at least one terminating MCData client device, a file download response from the MCData server.

Accordingly, the embodiment herein is to provide a terminating MCData client device for handling non-mandatory download procedure for FD over a media plane in a MCData network. The terminating MCData client device includes a non-mandatory download procedure controller communicatively coupled to a memory and a processor. The non-mandatory download procedure controller is configured to receive a MCData FD request comprising a non-mandatory download indication for file download from a MCData server. Further, the non-mandatory download procedure controller is configured to generate a user consent for the file download, where the user consent indicates one of MCData user accepted the request for the file download, the MCData user declined the request for the file download, and the MCData user deferred the request for the file download. Further, the non-mandatory download procedure controller is configured to perform one of send a MCData FD response comprising the user consent to the MCData server, or send a MCData FD response to the MCData server and send a FD disposition notification comprising the user consent to the MCData server.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### Advantageous Effects

The embodiments provide an efficient method for handling non-mandatory download for file distribution (FD) over a media plane in the MCData network.

### DESCRIPTION OF DRAWINGS

The embodiments are illustrated in the accompanying drawings, throughout which like reference letters indicate corresponding parts in the various figures. The embodiments herein will be better understood from the following description with reference to the drawings, in which:

FIG. 1 illustrates a scenario of handling of a FD request for non-mandatory file download by a MCData user at a MCData client, according to the embodiments as disclosed herein;

FIGS. 2A and 2B illustrate a scenario of sending disposition notification for mandatory/non-mandatory download procedures from a MCData client, according to the embodiments as disclosed herein;

FIGS. 3A and 3B illustrate a scenario of sending disposition notification for mandatory/non-mandatory download procedures from a MCData server, according to the embodiments as disclosed herein;

FIG. 4 illustrates a scenario of non-mandatory download procedures for supporting auto-receive from a MCData server, according to the embodiments as disclosed herein;

FIG. 5 illustrates a scenario to enable a later delivery of the FD request if a MCData user is not available or network is congested, according to the embodiments as disclosed herein;

FIG. 6 illustrates a scenario to enable the later delivery of the FD request if the MCData user has deferred an incoming FD request, according to the embodiments as disclosed herein;

FIG. 7 shows various hardware components of the MCData server, according to the embodiments as disclosed herein;

FIG. 8 shows various hardware components of a terminating MCData client device, according to the embodiments as disclosed herein;

FIG. 9 is a flow chart illustrating a method, implemented by the MCData server, for handling non-mandatory download procedure for the FD over the media plane in the MCData network, according to the embodiments as disclosed herein; and

FIG. 10 is a flow chart illustrating a method, implemented by the terminating MCData client device, for handling non-mandatory download procedure for the FD over the media plane in the MCData network, according to the embodiments as disclosed herein.

### MODE FOR INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

Accordingly the embodiment herein is to provide a method for handling non-mandatory download procedure for FD over a media plane in a MCData network. The method includes receiving, by a MCData server, a MCData FD request comprising a non-mandatory download indication for a file download from an originating MCData client device. Further, the method includes determining, by the MCData server, whether at least one of auto-receive configuration is enabled for the file download at the MCData server and a file download criteria is met. In an embodiment, the method includes receiving user consent for the file download from at least one terminating MCData client device of a plurality of the terminating MCData client devices, and sending a MCData FD response to the originating MCData client device based on the received user consent from the at least one terminating MCData client device in response to determining that the auto-receive configuration is not enabled and the file download criteria is met. The user consent indicates one of MCData user accepted the request for the file download, the MCData user declined the request for the file download, and the MCData user deferred the request for the file download. In another embodiment, the method includes converting the non-mandatory download indication to a mandatory download indication, sending a MCData FD request comprising the mandatory download to at least one terminating MCData client device of the plurality of the terminating MCData client devices, and sending a MCData FD response to the originating MCData client device based on the received user consent from the at least one terminating MCData client device in response to determining that the auto-receive configuration is enabled and the file download criteria is met. The user consent indicates MCData user accepted the request for the file download. In another embodiment, the method includes sending a MCData FD response to the originating MCData client device, receiving the file distributed over the media plane from the originating MCData client device, and storing the file for later deliver as the file download criteria for at least one terminating MCData client device of the plurality of at least one terminating MCData client devices is not met in response to determining that the file download criteria is not met irrespective of the auto-receive configuration is enabled or disabled.

The proposed method can be used to handle non-mandatory download procedure for file distribution using media plane with additional functionalities support such as auto-receive of distributed file, generate and send the disposition notifications of user actions and file download complete indication and later delivery of the FD request (i.e. group communication or 1-1 communication) with file content in the mission critical services. Such procedures and capabilities are very critical for the public safety agencies and the mission critical (MC) operations. This functionality is very much required for public safety users during emergency conditions where the sharing of file, auto-receive and sending of disposition notifications in time critical manner is very important.

The proposed method enables a terminating user to receive the shared file using non-mandatory download procedure over the media plane. Further, the proposed method enables the terminating user to auto-receive the shared file using non-mandatory download procedure over the media plane. Further, the proposed method enables the MCData server to support the later delivery of the FD request with the file content. Further, the proposed method enables the terminating user to send the disposition notification of the user actions and the file download complete indication. Further, the proposed method enables the MCData server to handle the sending of the disposition notification of the user actions and the file download complete indication.

In MCData systems/network, the FD using media plane procedure supports both mandatory and non-mandatory file download indication for both group communication and 1-1 communication. When the MCData user wants to send the file to other MCData user or MCData Group, the MCData user can indicate in the FD request with mandatory or non-mandatory download of the file is required. The file sent from the MCData client, the sending MCData user over the media plane using non-mandatory download indication allows the receiving MCData client to accept download, defer download or reject by the MCData user. On receiving the FD request, the receiving client will wait for MCData user acceptance in case of non-mandatory download or auto accept the FD request without waiting for the MCData user acceptance in case of mandatory download. The FD service requires the MCData user who is sending the file to be notified about the recipient MCData user action (such as MCData user accepts the FD session invitation, the MCData user declines the FD session invitation or the MCData user defer the FD session invitation) and a file download completed update indication if the sender has requested for it.

If the auto-receive is configured (i.e. in MCData service configuration or MCData group configuration) at the MCData server for the file download then the MCData server shall include the mandatory download indication in the FD request for receiving MCData user to download the file automatically by MCData client without the MCData user consent. Sometimes there is need for the MCData server to store the FD request (i.e. group communication or 1-1 communication) for the later delivery to enable the loss less communication or store and forward function that is required in case of specific group, user, or need basis etc. If the recipient MCData user is not available at the time of FD request or network congestion or FD request deferred by the MCData user, then the FD request will be stored in the storage maintained by the MCData server along with the file content for the later delivery. Such procedures and capabilities are very critical for the public safety agencies and the mission critical (MC) operations.

Currently there is no procedure exists:
For the receiving MCData user at the MCData client to download the file when non-mandatory file download indication is included in the FD request,
In order to download the file automatically without user consent if the auto-receive is configured (i.e. in MCData service configuration or MCData group configuration) at the MCData server for the file download,
In order to notify the MCData user action for receiving of the distributed file to an MCData user at the MCData client that requested for the file distribution and updating about the file download completion status if the sender has requested for it, and
In order to handle the FD request (i.e. group communication or 1-1 communication) with/without file content for a later delivery.

Unlike to the conventional methods and systems, the proposed method is defining a procedure to address above problem. The proposed method:

Offers a way for the MCData user at the MCData client to manage the download of the file over the media plane when non-mandatory file download indication is included in the FD request.

Enables the MCData server to include the mandatory indication while sending the FD request to the receiving MCData user(s) if the auto-receive configuration is enabled for the file download.

Provides a mechanism for MCData Server or receiving MCData client to generate and sending of the receiving MCData user action to an MCData user at MCData client that requested for the file distribution and updating about the file download completion status to the sender if requested for it, and

To the MCData server to store the FD request with the file content for a later delivery in the mission critical services.

The proposed method defining unique procedure to address above mentioned problem. The proposed method is introducing the new procedure at the MCData client to handle the download of the file when the non-mandatory download indication is included in the FD request along with sending of MCData user actions (such as MCData user accepts the FD session invitation, the MCData user declines the FD session invitation or the MCData user defers the FD session invitation) and a file download completed update indication if the sender has requested for it.

The MCData user actions and file download completed indications are sent as a disposition notifications. New procedure introduced in the MCData server to handle the FD request while an auto-receive setting is enabled for the file download and MCData server can include the mandatory download indication before sending the FD request to the receiving MCData user(s) if the FD request is for the non-mandatory case. This enables the target MCData user(s) to auto accept the FD request and compelled to download the file immediately. In another procedure, the MCData server will store the FD request (i.e. group communication or 1-1 communication) along with the file content for the later delivery if the receiving MCData user is not available at the time of file delivery or network is congested or FD request is deferred by the MCData user (i.e. group communication or 1-1 communication).

The file for the later delivery can be stored in the MCData server or content server or any other storage/server/entity and the FD request is updated with the URL of the stored file location appropriately. Later, if the receiving MCData user(s) decides to download the deferred requests then the MCData client send the request to download the deferred request using signalling plane procedures. On receiving of the deferred request, the MCData user choose to download the file, then the MCData client send the request to download the file content using media plane (msrp) or signalling plane (http).

In an alternate proposal, the MCData server generates and send the disposition notifications of the receiving MCData user action (such as MCData user accepts the FD session invitation, the MCData user declines the FD session invitation or the MCData user defers the FD session invitation) and a file download completed update indication if the sender has requested for it.

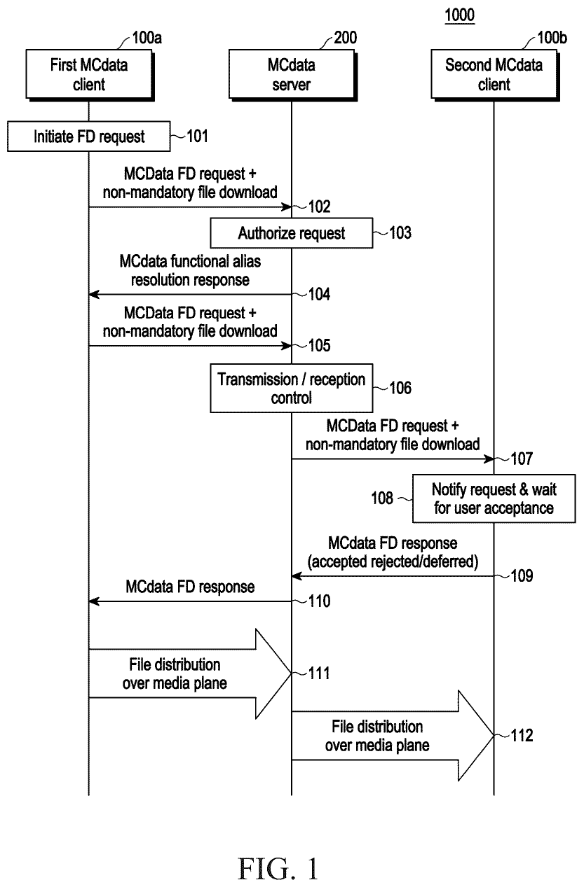

Referring now to the drawings and more particularly to FIGS. 1 through 10, where similar reference characters denote corresponding features consistently throughout the figures, there are shown preferred embodiments.

FIG. 1 illustrates a scenario of handling of the FD request for non-mandatory file download by MCData user at the MCData client (100a-100n), according to the embodiments as disclosed herein.

Referring to the FIG. 1 consider a proposed method, illustrates the scenario of receiving the MCData client supporting the non-mandatory download procedures. On receiving of the FD request for non-mandatory file download, the MCData client (100) accepts the incoming request or reject or decide to defer it. The response to the incoming FD request will carry the appropriate warning text if rejected or deferred and no warning text for the acceptance response of the incoming FD request.

The below procedure describes the MCData client actions to be performed on receiving of FD request for the non-mandatory download using the media plane procedure. The incoming FD request is notified to the MCData user and based on the MCData user actions to accept, reject, or defer the communication, an appropriate response will be sent to the terminating participating function.

### MCData Client Terminating Procedures:

Upon receipt of a “SIP INVITE request for file distribution for terminating MCData client”, the MCData client—

If any of the validations or pre-conditions are not met, may reject the SIP INVITE request with appropriate reject code as specified in 3GPP TS 24.229 and warning texts as specified in subclause 4.9 of 3GPP TS 24.282 or with SIP 480 (Temporarily unavailable) response not including warning texts if the user is authorised to restrict the reason for failure and skip the rest of the steps of this subclause;
may display to the MCData user the MCData ID of the inviting MCData user;
may display to the MCData user the functional alias of the inviting MCData user, if provided;
may display to the MCData user the file meta-data of the incoming file as described by the SDP included in the received SIP INVITE request;
if the application/vnd.3gpp.mcdata-signalling MIME body in the received SIP INVITE request contained a FD SIGNALLING PAYLOAD message without the Mandatory download IE included, then:
shall notify the MCData user about the incoming FD request and wait for the MCData user to accept or reject or defer the FD request;
if the MCData user declines the FD session invitation:
shall send a SIP 480 (Temporarily Unavailable) response towards the MCDATA server with the warning text set to: “110 user declined the call invitation” in a Warning header field as specified in clause 4.9 of 3GPP TS 24.282; and skip the rest of the steps in this clause;
if the MCData user defers the FD session invitation:
shall send a SIP 480 (Temporarily Unavailable) response towards the MCDATA server with the warning text set to: “231 user deferred the call invitation” in a Warning header field as specified in clause 4.9 of 3GPP TS 24.282; and skip the rest of the steps in this clause;
if the MCData user accepts the FD session invitation:
shall accept the SIP INVITE request and generate a SIP 200 (OK) response according to rules and procedures of 3GPP TS 24.229;
shall include the option tag “timer” in a Require header field of the SIP 200 (OK) response;
shall include the Session-Expires header field in the SIP 200 (OK) response and start the SIP session timer according to Internet Engineering Task Force Request for Comments (IETF RFC) 4028. The “refresher” parameter in the Session-Expires header field shall be set to “uas”;
shall include the g.3gpp.mcdata.fd media feature tag in the Contact header field of the Session Initiation Protocol (SIP) 200 (OK) response;
shall include the g.3gpp.icsi-ref media feature tag containing the value of “urn:urn-7:3gpp-service.ims.icsi.mcdata.fd” in the Contact header field of the SIP 200 (OK) response;
shall include a Session Description Protocol (SDP) answer in the SIP 200 (OK) response to the SDP offer in the incoming SIP INVITE request according to 3GPP TS 24.229 with the clarifications given in subclause 10.2.5.2.2 of 3GPP TS 24.282;
shall send the SIP 200 (OK) response towards the MCData server (200) according to rules and procedures of 3GPP TS 24.229;
may store the Conversation ID, Message ID, InReplyTo message ID and Date and time in local storage.

Warning texts: The Table (1) defines the new warning texts that are defined for the warning header field when a Warning header field is included in a response to a SIP INVITE request as specified in subclause 4.9.1 of 3GPP TS 24.282.

TABLE 1
Warning texts defined for the Warning header field

| Code | Explanatory text | Description |
|---|---|---|
| 110 | user declined the | The MCData user |
| | call invitation | declined to accept the call |
| | | for the file distribution. |
| 231 | user deferred the | The MCData user |
| | call invitation | deferred the call invitation |
| | | for the file distribution. |

As shown in the FIG. 1, at 101, the first MCData client (100a) initiates the FD request. At 102, the first MCData client (100a) sends the MCData FD request along with the non-mandatory file download to the MCData server (200). At 103, the MCData server (200) authorizes the request. At 104, the MCData server (200) sends a MCData Functional alias resolution response to the first MCData client (100a). At 105, the first MCData client (100a) sends the MCData FD request along with the non-mandatory file download to the MCData server (200).

At 106, the MCData server (200) performs the transmission/reception control. At 107, MCData server (200) sends the MCData FD request along with the non-mandatory file download to the second MCData client (100b). At 108, the second MCData client (100b) notifies the request and waits for the user acceptance.

At 109, the second MCData client (100b) sends the MCData FD response (including the accepted/rejected/deferred) to the MCData server (200). At 110, the MCData server (200) sends the MCData FD response to the first MCData client (100a). At 111, the first MCData client (100a) sends the file distribution over media plane to the MCData server (200). At 112, the MCData server (200) sends the file distribution over media plane second MCData client (100b).

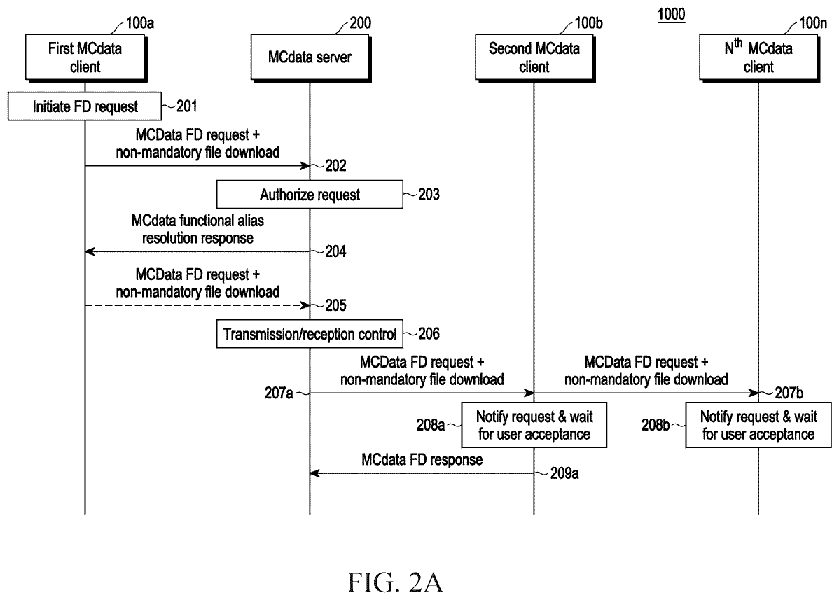

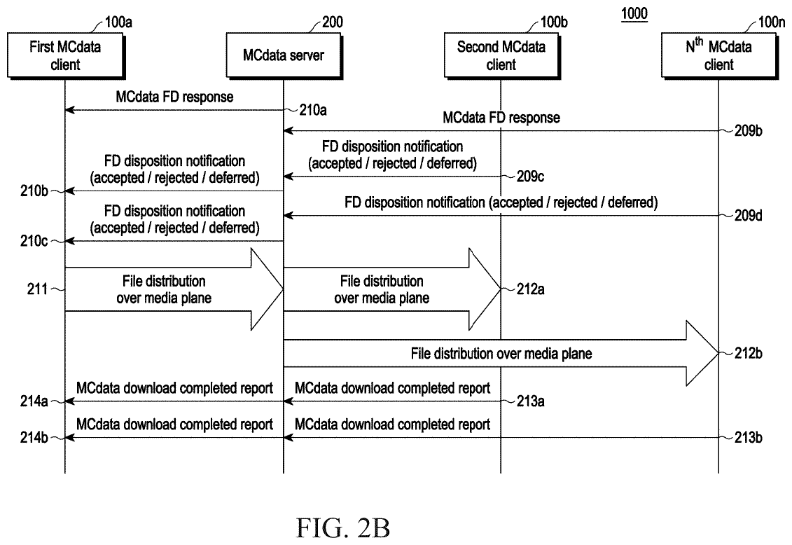

FIGS. 2A and 2B illustrate a scenario of sending disposition notification for mandatory/non-mandatory download procedures from the MCData client, according to the embodiments as disclosed herein.

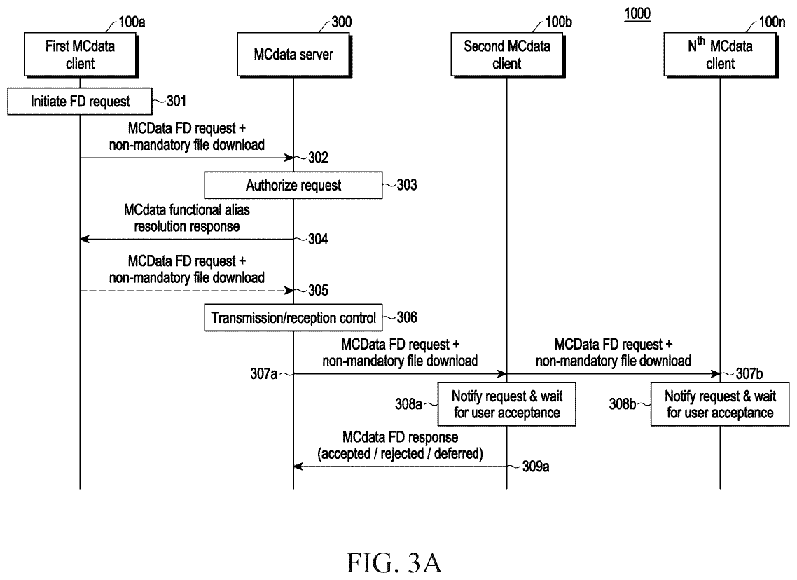

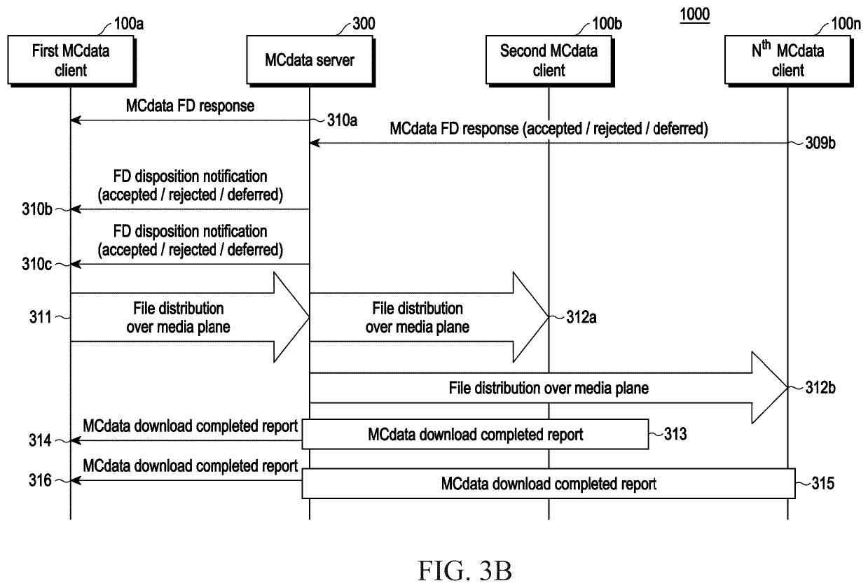

FIGS. 3A and 3A illustrate a scenario of sending disposition notification for mandatory/non-mandatory download procedures from the MCData server (200), according to the embodiments as disclosed herein.

Referring to the FIGS. 2A and 3B consider a proposed method, illustrate the scenario of sending disposition notification for mandatory/non-mandatory download procedures.

On receiving of the FD request for the non-mandatory file download, the MCData user accept the incoming request or reject or decide to defer it. An appropriate response will be sent for the incoming FD request based on the MCData user action and separate disposition notification are sent accordingly by the MCData client. As an alternate, the MCData server (200) can send the separate disposition notification on receiving the response for the FD request instead of MCData client.

This method provides two options as follows:
Receiving MCData client sending disposition notification, and
MCData server (200) sending disposition notification
Receiving MCData client sending disposition notification: The procedure describes the MCData client sending disposition notification based on the MCData user actions on receiving of FD request for non-mandatory download using media plane procedure, auto accepting of the FD request without the MCData user action for mandatory download using media plane procedure, and file download complete indication whether the sender has requested or not. The incoming FD request is notified to the MCData user for non-mandatory download and based on the MCData user actions to accept, reject, or defer the incoming FD request, an appropriate response is sent to the Terminating Participating function followed by sending of the corresponding disposition notification by the MCData client.

In case of mandatory download FD request, the FD request will be accepted by the receiving MCData client without MCData user acceptance and send the accept response followed by sending of the corresponding disposition notification by MCData client.

MCData client terminating procedures: Upon receipt of a “SIP INVITE request for file distribution for terminating MCData client”, the MCData client:
if any of the validations or pre-conditions are not met, may reject the SIP INVITE request with appropriate reject code as specified in 3GPP TS 24.229 and warning texts as specified in subclause 4.9 of 3GPP TS 24.282 or with SIP 480 (Temporarily unavailable) response not including warning texts if the user is authorised to restrict the reason for failure and skip the rest of the steps of this subclause;
may display to the MCData user the MCData ID of the inviting MCData user;
may display to the MCData user the functional alias of the inviting MCData user, if provided;
may display to the MCData user the file meta-data of the incoming file as described by the SDP included in the received SIP INVITE request;
if the Mandatory download IE of the FD SIGNALLING PAYLOAD contained in the application/vnd.3gpp.mcdata-signalling MIME body received in the SIP INVITE request is set to “MANDATORY DOWNLOAD”, then:
shall accept the SIP INVITE request and generate a SIP 200 (OK) response according to rules and procedures of 3GPP TS 24.229;
shall include the option tag “timer” in a Require header field of the SIP 200 (OK) response;
shall include the Session-Expires header field in the SIP 200 (OK) response and start the SIP session timer according to IETF RFC 4028. The “refresher” parameter in the Session-Expires header field shall be set to “uas”;
shall include the g.3gpp.mcdata.fd media feature tag in the Contact header field of the SIP 200 (OK) response;
shall include the g.3gpp.icsi-ref media feature tag containing the value of “urn:urn-7:3gpp-service.ims.icsi.mcdata.fd” in the Contact header field of the SIP 200 (OK) response;
shall include an SDP answer in the SIP 200 (OK) response to the SDP offer in the incoming SIP INVITE request according to 3GPP TS 24.229 with the clarifications given in subclause 10.2.5.2.2 of 3GPP TS 24.282;
shall send the SIP 200 (OK) response towards the MCData server (200) according to rules and procedures of 3GPP TS 24.229;
shall generate an FD NOTIFICATION indicating acceptance of the FD request as specified in subclause 12.2.1.1 of 3GPP TS 24.282;
if the FD SIGNALLING PAYLOAD message contains a new Conversation ID, shall instantiate a new conversation with the Message ID in the FD SIGNALLING PAYLOAD identifying the first message in the conversation thread;
if the FD SIGNALLING PAYLOAD message contains an existing Conversation ID and—
if the FD SIGNALLING PAYLOAD message does not contain an InReplyTo message ID, shall use the Message ID in the FD SIGNALLING PAYLOAD to identify a new message in the existing conversation thread; and
if the FD SIGNALLING PAYLOAD message contains an InReplyTo message ID, shall associate the message to an existing message in the conversation thread as identified by the InReplyTo message ID in the FD SIGNALLING PAYLOAD, and use the Message ID in the FD SIGNALLING PAYLOAD to identify the new message; and
may store the Conversation ID, Message ID, InReplyTo message ID and Date and time in local storage;
if the application/vnd.3gpp.mcdata-signalling MIME body in the received SIP INVITE request contained a FD SIGNALLING PAYLOAD message without the Mandatory download IE included, then:
shall notify the MCData user about the incoming FD request and wait for the MCData user to accept or reject or defer the FD request;
if the MCData user declines the FD session invitation—
shall send a SIP 480 (Temporarily Unavailable) response towards the MCData server with the warning text set to: “110 user declined the call invitation” in a Warning header field as specified in clause 4.9 of 3GPP TS 24.282; and
shall generate and send an FD NOTIFICATION indicating rejection of the FD request as specified in subclause 12.2.1.1 of 3GPP TS 24.282; and skip the rest of the steps in this clause;
if the MCData user defers the FD session invitation:
shall send a SIP 480 (Temporarily Unavailable) response towards the MCData server with the warning text set to: “231 user deferred the call invitation” in a Warning header field as specified in clause 4.9 of 3GPP TS 24.282; and
shall generate and send an FD NOTIFICATION indicating deferral of the FD request as specified in subclause 12.2.1.1 of 3GPP TS 24.282; and skip the rest of the steps in this clause;
if the MCData user accepts the FD session invitation—
shall accept the SIP INVITE request and generate a SIP 200 (OK) response according to rules and procedures of 3GPP TS 24.229;
shall include the option tag “timer” in a Require header field of the SIP 200 (OK) response;
shall include the Session-Expires header field in the SIP 200 (OK) response and start the SIP session timer according to IETF RFC 4028. The “refresher” parameter in the Session-Expires header field shall be set to “uas”;
shall include the g.3gpp.mcdata.fd media feature tag in the Contact header field of the SIP 200 (OK) response;
shall include the g.3gpp.icsi-ref media feature tag containing the value of “urn:urn-7:3gpp-service.ims.icsi.mcdata.fd” in the Contact header field of the SIP 200 (OK) response;
shall include an SDP answer in the SIP 200 (OK) response to the SDP offer in the incoming SIP INVITE request according to 3GPP TS 24.229 with the clarifications given in subclause 10.2.5.2.2 of 3GPP TS 24.282;
shall send the SIP 200 (OK) response towards the MCData server (200) according to rules and procedures of 3GPP TS 24.229;
shall generate an FD NOTIFICATION indicating acceptance of the FD request as specified in subclause 12.2.1.1 of 3GPP TS 24.282;
if the FD SIGNALLING PAYLOAD message contains a new Conversation ID, shall instantiate a new conversation with the Message ID in the FD SIGNALLING PAYLOAD identifying the first message in the conversation thread;
if the FD SIGNALLING PAYLOAD message contains an existing Conversation ID and:
if the FD SIGNALLING PAYLOAD message does not contain an InReplyTo message ID, shall use the Message ID in the FD SIGNALLING PAYLOAD to identify a new message in the existing conversation thread; and
if the FD SIGNALLING PAYLOAD message contains an InReplyTo message ID, shall associate the message to an existing message in the conversation thread as identified by the InReplyTo message ID in the FD SIGNALLING PAYLOAD, and use the Message ID in the FD SIGNALLING PAYLOAD to identify the new message; and
may store the Conversation ID, Message ID, InReplyTo message ID and Date and time in local storage.

On receipt of an SIP ACK message to the sent SIP 200 (OK) message, the MCData client shall:
shall interact with the media plane as specified in 3GPP TS 24.582 subclause 7.1.3 of 3GPP TS 24.282.

On receipt of an indication from the media plane of the successful download of the file or on successful download of the file after retrieval of deferred FD request, and if the received FD SIGNALLING PAYLOAD message contained an FD disposition request type IE requesting a file download completed update indication, then, the MCData client:
shall follow the procedures described in subclause 12.2.1.1 of 3GPP TS 24.282.

MCData server sending disposition notification: Alternatively, instead of MCData client, the MCData server (200) can handle the sending of disposition notification based on the received MCData user actions on receiving of FD request for non-mandatory download using media plane procedure, auto accepting of the FD request without the MCData user action for mandatory download using media plane procedure, and file download complete indication whether the sender has requested for it. The MCData server (200) generates the disposition notification and sends it to the originating MCData client to notify about the terminating MCData user actions and the file download complete indication.

Terminating participating MCData function procedures: Upon receipt of a “SIP INVITE request for file distribution for terminating participating MCData function”, the participating MCData function:
shall use the MCData ID present in the <mcdata-request-uri> element of the application/vnd.3gpp.mcdata-info+xml MIME body of the incoming SIP INVITE request to retrieve the binding between the MCData ID and public user identity of the terminating MCData user;
if the binding between the MCData ID and public user identity of the terminating MCData user does not exist (i.e. MCData user is not available) or network congestion exists, and if the later delivery is required (as per the local policy or configuration or any other settings), then the participating MCData function shall store the communication for later delivery with following additional information included:
shall include a Payload IE with:
the Payload content type set to “FILEURL” as specified in subclause 15.2.13 of 3GPP TS 24.282; and
the URL of the file to be stored for the later delivery in the Payload data as specified in subclause 15.2.13 of 3GPP TS 24.282; and

The file can be stored in the temporary storage of the MCData server (200) or MCData content server. The URL of stored file for later delivery is updated accordingly.
may include a Metadata IE with the required file description information and file availability information;
2A. if the communication is stored in step 2) above and to store the file in the temporary storage, shall generate a SIP 200 (OK) response as specified in 3GPP TS 24.229 with the following clarifications:
shall include an SDP answer in the SIP 200 (OK) response to the SDP offer in the incoming SIP INVITE request according to 3GPP TS 24.229 [5] with the following clarifications:
i) shall include an “m=message” media-level section for the accepted MCData media stream consisting of:
A) shall include the IP address and port number of the participating MCData function, for the accepted media stream in the received SDP offer;
B) a protocol field value of “TCP/MSRP” or “TCP/TLS/MSRP” for TLS according to the received SDP offer;
C) a format list field set to ‘*’;
D) an “a=recvonly” attribute;
E) an “a=path” attribute containing its own MSRP URI;
F) set the content type as a=accept-types:application/vnd.3gpp.mcdata-signalling; and
G) set the a=setup attribute set to “passive”, according to IETF RFC 6135 [19];
b) shall include the option tag “timer” in a Require header field;
c) shall include the Session-Expires header field according to rules and procedures of IETF RFC 4028 [38], “UAS Behavior”. If no “refresher” parameter was included in the SIP INVITE request, the “refresher” parameter in the Session-Expires header field shall be set to “uas”;
d) shall include the following in the Contact header field:
i) the g.3gpp.mcdata.fd media feature tag;
ii) the g.3gpp.icsi-ref media feature tag containing the value of “urn:urn-7:3gpp-service.ims.icsi.mcdata.fd”; and
iii) an MCData session identity mapped to the MCData session identity provided in the Contact header field of the received SIP INVITE request from the controlling MCData function;
e) shall start the SIP Session timer according to rules and procedures of IETF RFC 4028 [38];
f) shall include the warning text set to “232 Communication is stored for the later delivery” in a Warning header field as specified in subclause 4.9;
g) shall interact with the media plane as specified in 3GPP TS 24.582 [15] subclause 7.2.5.1 to receive the file from controlling MCData function and subclause 7.1.3.2 to receive the file content; and
h) shall send the SIP 200 (OK) response to the controlling MCData function according to 3GPP TS 24.229 [5];
f) shall generate and send an FD NOTIFICATION indicating deferral of the FD request as specified in subclause 12.2.2.X of 3GPP TS 24.282 with including the warning text set to “232 Communication is stored for the later delivery” in a Warning header field as specified in subclause 4.9;
and skip the rest of the steps of this subclause;
shall generate a SIP INVITE request accordance with 3GPP TS 24.229;
shall/may include required header field and corresponding values, such as Session-Expires, Accept-Contact, Referred-By, Contact, P-Asserted-Identity, ICSI value, and application/vnd.3gpp.mcdata-info+xml MIME body;
shall set the Request-URI of the outgoing SIP INVITE request to the public user identity associated to the MCData ID of the terminating MCData user;
shall populate the outgoing SIP INVITE request with the MIME bodies that were present in the incoming SIP INVITE request;
shall send the SIP INVITE request as specified in 3GPP TS 24.229.

Upon receipt of a SIP 200 (OK) response in response to the above SIP INVITE request, the participating MCData function:
shall generate a SIP 200 (OK) response as specified in 3GPP TS 24.229;
shall include in the SIP 200 (OK) response an SDP answer based on the SDP answer in the received SIP 200 (OK) response as specified in subclause 10.2.5.3.2 of 3GPP TS 24.282;
shall interact with the media plane as specified in 3GPP TS 24.582 subclause 7.2.2;
shall send the SIP 200 (OK) response to the controlling MCData function according to 3GPP TS 24.229;
shall generate an FD NOTIFICATION indicating acceptance of the FD request as specified in subclause 12.2.2.X of 3GPP TS 24.282;
if the FD SIGNALLING PAYLOAD message contains a new Conversation ID in the sent SIP INVITE request, shall instantiate a new conversation with the Message ID in the FD SIGNALLING PAYLOAD identifying the first message in the conversation thread;
if the FD SIGNALLING PAYLOAD message contains an existing Conversation ID in the sent SIP INVITE request and—
if the FD SIGNALLING PAYLOAD message does not contain an InReplyTo message ID, shall use the Message ID in the FD SIGNALLING PAYLOAD to identify a new message in the existing conversation thread; and
if the FD SIGNALLING PAYLOAD message contains an InReplyTo message ID, shall associate the message to an existing message in the conversation thread as identified by the InReplyTo message ID in the FD SIGNALLING PAYLOAD, and use the Message ID in the FD SIGNALLING PAYLOAD to identify the new message.

Upon receiving a SIP 480 (Temporarily Unavailable) response with the warning text set to: “231 user deferred the call invitation” in the warning header field as specified in clause 4.9 of 3GPP TS 24.282 to the above SIP INVITE request and if the later delivery is required, the participating MCData function:
shall store the communication for later delivery with following additional information included—
shall include a Payload IE with:
the Payload content type set to “FILEURL” as specified in subclause 15.2.13 of 3GPP TS 24.282; and
the URL of the file to be stored for the later delivery in the Payload data as specified in subclause 15.2.13 of 3GPP TS 24.282; and

The file can be stored in the temporary storage of the MCData server (200) or MCData content server. The URL of stored file for later delivery is updated accordingly.
may include a Metadata IE with the required file description information and file availability information;
if the communication is stored in step 1) above and to store the file in the temporary storage, shall generate a SIP 200 (OK) response as specified in 3GPP TS 24.229 with the following clarifications:
a) shall include an SDP answer in the SIP 200 (OK) response to the SDP offer in the incoming SIP INVITE request according to 3GPP TS 24.229 with the following clarifications:
i) shall include an “m-message” media-level section for the accepted MCData media stream consisting of:
A) shall include the IP address and port number of the participating MCData function, for the accepted media stream in the received SDP offer;
B) a protocol field value of “TCP/MSRP” or “TCP/TLS/MSRP” for TLS according to the received SDP offer;
C) a format list field set to ‘*’;
D) an “a=recvonly” attribute;
E) an “a-path” attribute containing its own MSRP URI;
F) set the content type as a-accept-types:application/vnd.3gpp.mcdata-signalling; and
G) set the a=setup attribute set to “passive”, according to IETF RFC 6135;
b) shall include the option tag “timer” in a Require header field;
c) shall include the Session-Expires header field according to rules and procedures of IETF RFC 4028, “UAS Behavior”. If no “refresher” parameter was included in the SIP INVITE request, the “refresher” parameter in the Session-Expires header field shall be set to “uas”;
d) shall include the following in the Contact header field:
i) the g.3gpp.mcdata.fd media feature tag;
ii) the g.3gpp.icsi-ref media feature tag containing the value of “urn:urn-7:3gpp-service.ims.icsi.mcdata.fd”; and
iii) an MCData session identity mapped to the MCData session identity provided in the Contact header field of the received SIP INVITE request from the controlling MCData function;
e) shall start the SIP Session timer according to rules and procedures of IETF RFC 4028;
f) shall include the warning text set to “232 Communication is stored for the later delivery” in a Warning header field as specified in subclause 4.9 of 3GPP TS 24.282;
g) shall interact with the media plane as specified in 3GPP TS 24.582 subclause 7.2.5.1 to receive the file from controlling MCData function and subclause 7.1.3.2 to receive the file content; and
h) shall send the SIP 200 (OK) response to the controlling MCData function according to 3GPP TS 24.229; and
shall generate and send an FD NOTIFICATION indicating deferral of the FD request as specified in subclause 12.2.2.X of 3GPP TS 24.282.

Upon receipt of a SIP 4xx, 5xx or 6xx response to the above SIP INVITE request, the participating MCData function—
shall generate a SIP response according to 3GPP TS 24.229;
shall include Warning header field(s) that were received in the incoming SIP response;
shall forward the SIP response to the controlling MCData function according to 3GPP TS 24.229; and
shall generate and send an FD NOTIFICATION indicating rejection of the FD request as specified in subclause 12.2.2.X of 3GPP TS 24.282.

On receipt of an indication from the media plane of the successful download of the file or on successful download of the file after retrieval of deferred FD request and if the received FD SIGNALLING PAYLOAD message contained an FD disposition request type IE requesting a file download completed update indication in the sent SIP INVITE request, then, the participating MCData function:

Shall follow the procedures described in subclause 12.2.2.Xof 3GPP TS 24.282.

On receipt of an indication from the media plane of the successful download of the file for later delivery, the participating MCData function:
1) shall update the URL of the stored file for the later delivery in the Payload data.

### Warning Texts

The Table (2) defines the new warning texts that are defined for the Warning header field when a Warning header field is included in a response to a SIP INVITE request as specified in subclause 4.9.1 of 3GPP TS 24.282.

TABLE 2
Warning texts defined for the Warning header field

| Code | Explanatory text | Description |
|---|---|---|
| 232 | Communication is stored | The participating |
| | for the later delivery | MCData function stores |
| | | the communication for |
| | | later delivery if the |
| | | receiving MCData user is |
| | | not available at the time of |
| | | data delivery or network is |
| | | congested or request |
| | | deferred by the MCData |
| | | user. If the communication |
| | | is for the file distribution |
| | | then file content is also |
| | | stored. |

Participating MCData function sends a disposition notification message:
The participating MCData function shall follow the procedures in this subclause to:
indicate to an MCData client that a request for FD was accepted, deferred or rejected; or
indicate to an MCData client that a file download has been completed;

Before sending a disposition notification the participating MCData function needs to determine:

The group identity related to an FD message request received as part of a group communication. The participating MCData function determines the group identity from the contents of the <mcdata-calling-group-id> element contained in the application/vnd.3gpp.mcdata-info+xml MIME body of the incoming FD message request; and

The MCData user targeted for the disposition notification. The participating MCData function determines the targeted MCData user from the contents of the <mcdata-calling-user-id> element contained in the application/vnd.3gpp.mcdata-info+xml MIME body of the incoming FD message request.

The participating MCData function shall generate a SIP MESSAGE request in accordance with 3GPP TS 24.229 and IETF RFC 3428 with the clarifications given below. The participating MCData function:
shall build the SIP MESSAGE request as specified in subclause 6.3.2.X of 3GPP TS 24.282;
shall follow the rules specified in subclause 6.4 of 3GPP TS 24.282 for the handling of MIME bodies in a SIP message when processing the remaining steps in this subclause;
shall insert in the SIP MESSAGE request an application/resource-lists+xmlMIME body containing the MCData ID of the targeted MCData user, according to rules and procedures of IETF RFC 5366;
if sending a disposition notification in response to an MCData group data request, shall include an <mcdata-calling-group-id> element set to the MCData group identity in the application/vnd.3gpp.mcdata-info+xml MIME body;
shall include an application/vnd.3gpp.mcdata-info+xml MIME body in the outgoing SIP MESSAGE request, containing an <mcdata-calling-user-id> element set to the MCData ID of the associated disposition notification of the MCData user;
if requiring to send an FD notification, shall generate an FD NOTIFICATION message and include it in the SIP MESSAGE request as specified in subclause 6.3.X.1 of 3GPP TS 24.282; and
shall send the SIP MESSAGE request according to rules and procedures of 3GPP TS 24.229.

### 6.3.X Disposition Notifications

### 6.3.X.1 Generating an FD Notification

The proposed method provides scenario of disposition notification and generating the FD notification. In order to generate an FD notification, the participating MCData function—
shall generate an FD NOTIFICATION message as specified in subclause 15.1.6 of 3GPP TS 24.282; and
shall include in the SIP request, the FD NOTIFICATION message in an application/vnd.3gpp.mcdata-signalling MIME body as specified in subclause E.1 of 3GPP TS 24.282.

When generating an FD NOTIFICATION message as specified in subclause 15.1.6 of 3GPP TS 24.282, the participating MCData function—
if sending a file download accept notification, shall set the FD disposition notification type IE as “FILE DOWNLOAD REQUEST ACCEPTED” as specified in subclause 15.2.6 of 3GPP TS 24.282;
if sending a file download reject notification, shall set the FD disposition notification type IE as “FILE DOWNLOAD REQUEST REJECTED” as specified in subclause 15.2.6 of 3GPP TS 24.282;
if sending a file download deferred notification, shall set the FD disposition notification type IE as “FILE DOWNLOAD REQUEST DEFERRED” as specified in subclause 15.2.6 of 3GPP TS 24.282;
shall set the Conversation ID to the value of the Conversation ID that was received in the FD message as specified in subclause 15.2.9 of 3GPP TS 24.282;
shall set the Date and time IE to the current time as specified in subclause 15.2.8 of 3GPP TS 24.282; and
if sending a file download completed notification:
shall set the FD disposition notification type IE as “FILE DOWNLOAD COMPLETED” as specified in subclause 15.2.6 of 3GPP TS 24.282;
shall set the Message ID to the value of the Message ID that was received in the FD message as specified in subclause 15.2.10 of 3GPP TS 24.282;
if the FD message was destined for the user, shall not include an Application ID IE as specified in subclause 15.2.7 of 3GPP TS 24.282 and shall not include an Extended application ID IE as specified in subclause 15.2.24 of 3GPP TS 24.282; and
if the FD message was destined for an application, shall include—
an Application ID IE set to the value of the Application ID that was included in the FD message as specified in subclause 15.2.3 of 3GPP TS 24.282; or
an Extended application ID IE set to the value of the Extended application ID that was included in the FD message as specified in subclause 15.2.24 of 3GPP TS 24.282.

### 6.3.2.X Generating a SIP MESSAGE Request Towards the Controlling MCData Function

This subclause is referenced from other procedures. In a SIP MESSAGE request, the controlling MCData function—
shall generate a SIP MESSAGE request in accordance with 3GPP TS 24.229 and IETF RFC 3428;
shall set the Request-URI of the SIP MESSAGE request to the public service identity of the controlling MCData function;
shall include the ICSI value “urn:urn-7:3gpp-service.ims.icsi.mcdata.fd” (coded as specified in 3GPP TS 24.229), into the P-Asserted-Service header field of the SIP MESSAGE request; and
shall include a P-Asserted-Identity header field in the SIP MESSAGE request to the public user identity in the P-Asserted-Identity header field contained in the received SIP request specified in 3GPP TS 24.229.

As shown in the FIG. 2A, at 201, the first MCData client (100a) initiates the FD request. At 202, the first MCData client (100a) sends the MCData FD request along with the non-mandatory file download to the MCData server (200). At 203, the MCData server (200) authorizes the request. At 204, the MCData server (200) sends the MCData functional alias resolution response to the first MCData client (100a). At 205, the first MCData client (100a) sends the MCData FD request along with the non-mandatory file download to the MCData server (200). At 206, the MCData server (200) performs the transmission/reception control.

At 207a, the MCData server (200) sends the MCData FD request along with the non-mandatory file download to the second MCData client (100b). At 207b, the second MCData client (100b) sends the MCData FD request along with the non-mandatory file download to the Nth MCData client (100n). At 208a, the second MCData client (100b) notifies the request and waits for the user acceptance. At 208b, Nth MCData client (100n) notifies the request and waits for the user acceptance. At 209a, the second MCData client (100b) sends the MCData FD response to the MCData server (200).

As shown in the FIG. 2B, at 209b, the Nth MCData client (100n) sends the MCData FD response to the MCData server (200). At 210a, the MCData server (200) sends the MCData FD response to the first MCData client (100a).

At 209c, the second MCData client (100b) sends the FD disposition notification (including the accepted/rejected/deferred) to the MCData server (200). At 209d, Nth MCData client (100n) sends the FD disposition notification (including the accepted/rejected/deferred) to the MCData server (200). At 210b and 210c, the MCData server (200) sends the FD disposition notification (including the accepted/rejected/deferred) to the first MCData client (100a).

At 211, the first MCData client (100a) sends the file distribution over media plane to the MCData server (200). At 212a, the MCData server (200) sends the file distribution over media plane to the second MCData client (100b). At 212b, the MCData server (200) sends the file distribution over media plane to the nth MCData client (100n). At 13a, the second MCData client (100b) sends the MCData download completed report to the MCData server (200). At 214a, MCData server (200) sends the MCData download completed report to the first MCData client (100b). At 213b, the Nth MCData client (100n) sends MCData download completed report to the MCData server (200). At 214a, MCData server (200) sends the MCData download completed report to the first MCData client (100b).

As shown in the FIG. 3A, at 301, the first MCData client (100a) initiates the FD request. At 302, the first MCData client (100a) sends the MCData FD request along with the non-mandatory file download to the MCData server (200). At 303, the MCData server (200) authorizes the request. At 304, the MCData server (200) sends the MCData functional alias resolution response to the first MCData client (100a). At 305, the first MCData client (100a) sends the MCData FD request along with the non-mandatory file download to the MCData server (200). At 306, the MCData server (200) performs the transmission/reception control.

At 307a, the MCData server (200) sends the MCData FD request along with the non-mandatory file download to the second MCData client (100b). At 307b, the second MCData client (100b) sends the MCData FD request along with the non-mandatory file download to the Nth MCData client (100n). At 308a, the second MCData client (100b) notifies the request and waits for the user acceptance. At 308b, Nth MCData client (100n) notifies the request and waits for the user acceptance. At 309a, the second MCData client (100b) sends the MCData FD response to the MCData server (200).

As shown in the FIG. 3A, at 309b, the Nth MCData client (100n) sends the MCData FD response to the MCData server (200). At 310a, the MCData server (200) sends the MCData FD response to the first MCData client (100a). At 310b and 310c, the MCData server (200) sends the FD disposition notification (including the accepted/rejected/deferred) to the first MCData client (100a).

At 311, the first MCData client (100a) sends the file distribution over media plane to the MCData server (200). At 312a, the MCData server (200) sends the file distribution over media plane to the second MCData client (100b). At 312b, the MCData server (200) sends the file distribution over media plane to the nth MCData client (100n). At 313, the MCData download completed report is provided between the second MCData client (100b) and the MCData server (200). At 314, MCData server (200) sends the MCData download completed report to the first MCData client (100b). At 315, the MCData download completed report is provided between the Nth MCData client (100n) and the MCData server (200). At 316, MCData server (200) sends the MCData download completed report to the first MCData client (100b).

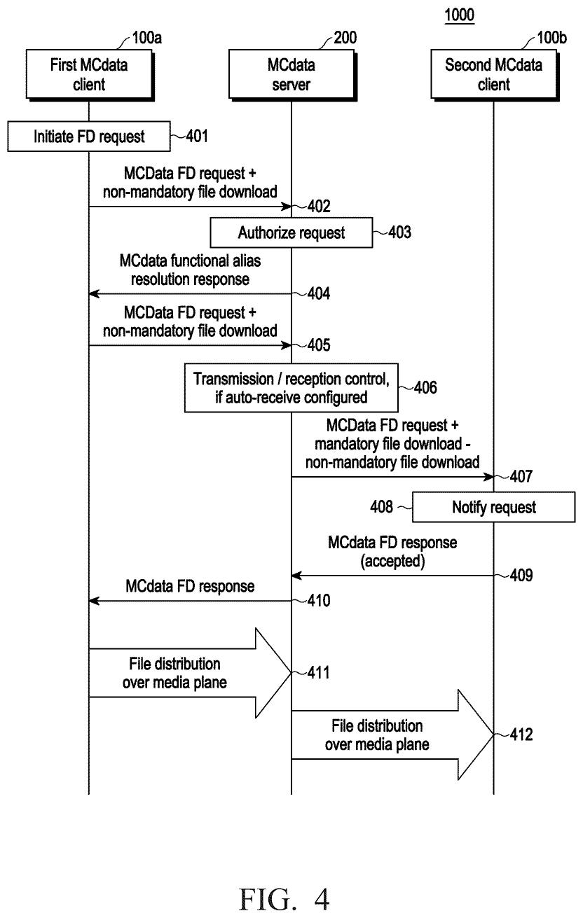

FIG. 4 illustrates a scenario of non-mandatory download procedures supporting auto-receive from MCData server (200), according to the embodiments as disclosed herein.

Referring to the FIG. 4 consider a proposed method, illustrates the non-mandatory download procedures supporting auto-receive. On receiving of the FD request for non-mandatory file download, the MCData server (200) can include the mandatory download indication in the FD request before sending it to the receiving MCData clients.

The procedure describes the MCData server (200) handling the receiving of FD request for non-mandatory download using media plane procedure while auto-receive configuration is enabled for the receiving MCData user. The MCData server (200) will include the mandatory download indication in the received FD request for non-mandatory download using media plane procedure before forwarding it to the terminating MCData client.

Originating controlling MCData function procedures: This method describes the procedures for inviting the MCData user to an FD session. The procedure is initiated by the controlling MCData function as the result of an action in subclause 10.2.5.4.4 of 3GPP TS 24.282.

The controlling MCData function:
shall generate a SIP INVITE as specified in subclause 6.3.7.1.11 of 3GPP TS 24.282;
shall/may include required header field and corresponding values, such as Session-Expires, Accept-Contact, Referred-By, Contact, P-Asserted-Identity, ICSI value, and application/vnd.3gpp.mcdata-info+xml MIME body;
shall include in the outgoing SIP INVITE request, the application/vnd.3gpp.mcdata-signalling MIME body that was present in the incoming SIP INVITE request;
if the application/vnd.3gpp.mcdata-signalling MIME body in the received SIP INVITE request contained a FD SIGNALLING PAYLOAD message without the Mandatory download IE included, then—
shall execute the procedures in subclause 11.2 of 3GPP TS 24.282;
if the procedures in subclause 11.2 of 3GPP TS 24.282 indicate that the mandatory download indication needs to be included, shall include the Mandatory download IE set to a value of “MANDATORY DOWNLOAD” in the FD SIGNALLING PAYLOAD message of the outgoing SIP INVITE request;
shall set the Request-URI to the public service identity of the terminating participating MCData function associated to the MCData user to be invited;
shall send the SIP INVITE request towards the terminating client in accordance with 3GPP TS 24.229.

As shown in the FIG. 4, at 401, the first MCData client (100a) initiates the FD request. At 402, the first MCData client (100a) sends the MCData FD request along with the non-mandatory file download to the MCData server (200). At 403, the MCData server (200) authorizes the request. At 404, the MCData server (200) sends a MCData functional alias resolution response to the first MCData client (100a). At 405, the first MCData client (100a) sends the MCData FD request along with the non-mandatory file download to the MCData server (200).

At 406, the MCData server (200) performs the transmission/reception control If auto-receive configured. At 407, MCData server (200) sends the MCData FD request along with the mandatory file download and the non-mandatory file download to the second MCData client (100b). At 408, the second MCData client (100b) notifies the request. At 409, the second MCData client (100b) sends the MCData FD response (including the accepted) to the MCData server (200). At 410, the MCData server (200) sends the MCData FD response to the first MCData client (100a). At 411, the first MCData client (100a) sends the file distribution over media plane to the MCData server (200). At 412, the MCData server (200) sends the file distribution over media plane second MCData client (100b).

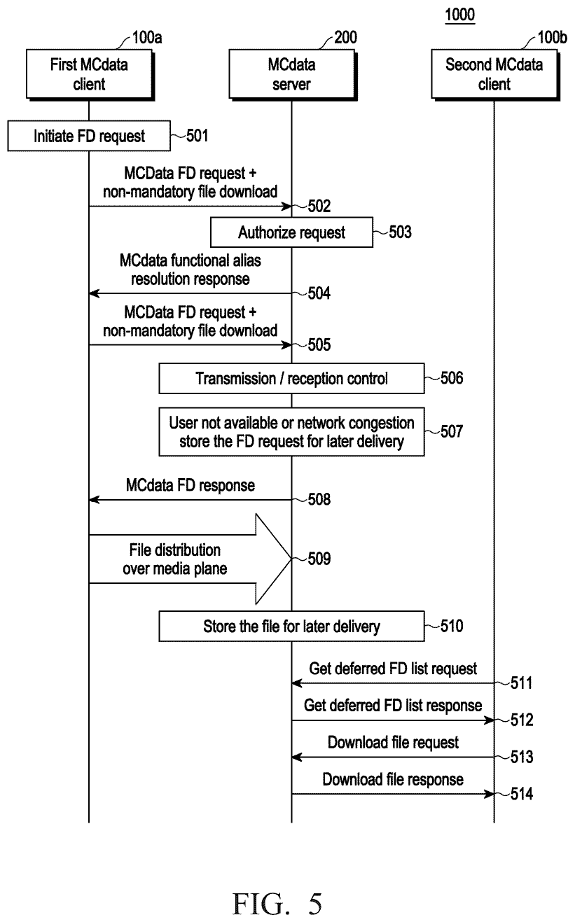

FIG. 5 illustrates a scenario to enable the later delivery of the FD request if the MCData user is not available or network is congested, according to the embodiments as disclosed herein.

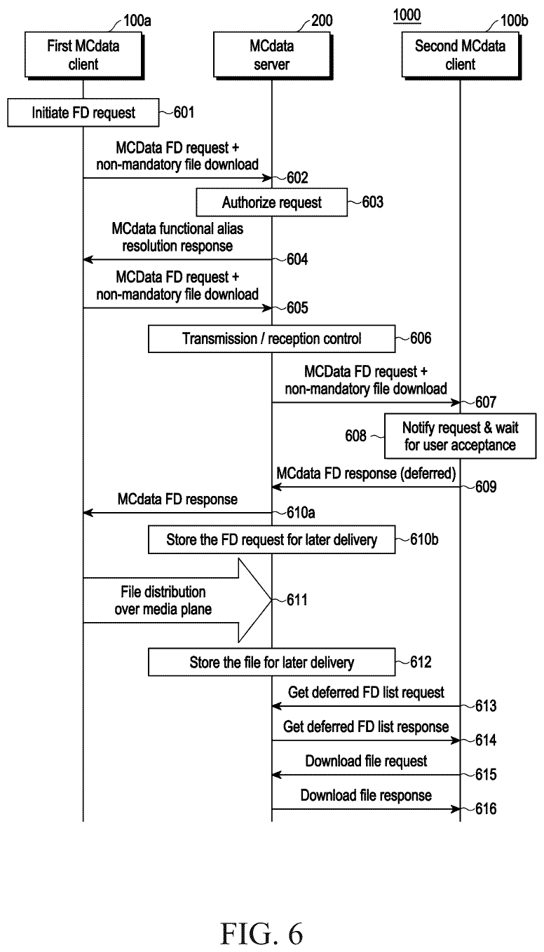

FIG. 6 illustrates a scenario to enable the later delivery of the FD request if the MCData user has deferred the incoming FD request, according to the embodiments as disclosed herein.

Referring to the FIGS. 5 and 6 consider a proposed method, illustrates the scenario of later delivery of the FD request (i.e. group communication or 1-1 communication) with/without file content.

The MCData server (200) will store the FD request (i.e. group communication or 1-1 communication) along with the file content for the later delivery if the receiving MCData user is not available at the time of file delivery or network is congested or FD request deferred by the MCData user (i.e. group communication or 1-1 communication). The file for the later delivery can be stored in the MCData server (200) or content server or any other storage/server/entity and the FD request is updated with the URL of the stored file location appropriately. Later, if the receiving MCData user(s) decides to download the deferred request then the MCData client sends the request to download the deferred request using signaling plane procedures. On receiving of the deferred request, the MCData user choose to download the file, then the MCData client send the request to download the file content using media plane (msrp) or signaling plane (http).

Alternatively, the file for later delivery can be stored in the content server or any other storage that is accessible/managed by the MCData server (200). The step 2a of incoming SIP INVITE handling and step 4a of SIP response 480 can have the URL of the stored file from content server or any other storage.

Terminating participating MCData function procedures-Upon receipt of a “SIP INVITE request for file distribution for terminating participating MCData function”, the participating MCData function—
shall use the MCData ID present in the <mcdata-request-uri> element of the application/vnd.3gpp.mcdata-info+xml MIME body of the incoming SIP INVITE request to retrieve the binding between the MCData ID and public user identity of the terminating MCData user;
if the binding between the MCData ID and public user identity of the terminating MCData user does not exist (i.e. MCData user is not available) or network congestion exists, and if the later delivery is required, then the participating MCData function shall store the communication for later delivery with following additional information included:
shall include a Payload IE with:
the Payload content type set to “FILEURL” as specified in subclause 15.2.13 of 3GPP TS 24.282; and
the URL of the file to be stored for the later delivery in the Payload data as specified in subclause 15.2.13 of 3GPP TS 24.282; and
The file can be stored in the temporary storage of the MCData server (200) or MCData content server. The URL of stored file for later delivery is updated accordingly.
may include a Metadata IE with the required file description information and file availability information;
2A) if the communication is stored in step 3A2) above and to store the file in the temporary storage, shall generate a SIP 200 (OK) response as specified in 3GPP TS 24.229 with the following clarifications:
a) shall include an SDP answer in the SIP 200 (OK) response to the SDP offer in the incoming SIP INVITE request according to 3GPP TS 24.229 with the following clarifications:
i) shall include an “m=message” media-level section for the accepted MCData media stream consisting of:
A) shall include the IP address and port number of the participating MCData function, for the accepted media stream in the received SDP offer;
B) a protocol field value of “TCP/MSRP” or “TCP/TLS/MSRP” for TLS according to the received SDP offer;
C) a format list field set to ‘*’;
D) an “a=recvonly” attribute;
E) an “a-path” attribute containing its own MSRP URI;
F) set the content type as a-accept-types:application/vnd.3gpp.mcdata-signalling; and
G) set the a-setup attribute set to “passive”, according to IETF RFC 6135;
b) shall include the option tag “timer” in a Require header field;
c) shall include the Session-Expires header field according to rules and procedures of IETF RFC 4028, “UAS Behavior”. If no “refresher” parameter was included in the SIP INVITE request, the “refresher” parameter in the Session-Expires header field shall be set to “uas”;
d) shall include the following in the Contact header field:
i) the g.3gpp.mcdata.fd media feature tag;
ii) the g.3gpp.icsi-ref media feature tag containing the value of “urn:urn-7:3gpp-service.ims.icsi.mcdata.fd”; and
iii) an MCData session identity mapped to the MCData session identity provided in the Contact header field of the received SIP INVITE request from the controlling MCData function;
e) shall start the SIP Session timer according to rules and procedures of IETF RFC 4028;
f) shall include the warning text set to “232 Communication is stored for the later delivery” in a Warning header field as specified in subclause 4.9 of 3GPP TS 24.282;
g) shall interact with the media plane as specified in 3GPP TS 24.582 subclause 7.2.5.1 to receive the file from controlling MCData function and subclause 7.1.3.2 to receive the file content; and
h) shall send the SIP 200 (OK) response to the controlling MCData function according to 3GPP TS 24.229;
and skip the rest of the steps of this subclause;
shall generate a SIP INVITE request accordance with 3GPP TS 24.229;
shall/may include required header field and corresponding values, such as Session-Expires, Accept-Contact, Referred-By, Contact, P-Asserted-Identity, ICSI value, and application/vnd.3gpp.mcdata-info+xml MIME body;
shall set the Request-URI of the outgoing SIP INVITE request to the public user identity associated to the MCData ID of the terminating MCData user;
shall populate the outgoing SIP INVITE request with the MIME bodies that were present in the incoming SIP INVITE request;
shall send the SIP INVITE request as specified in 3GPP TS 24.229.

Upon receiving a SIP 480 (Temporarily Unavailable) response with the warning text set to: “231 user deferred the call invitation” in a Warning header field as specified in clause 4.9 of 3GPP TS 24.282 to the above SIP INVITE request and if the later delivery is required, the participating MCData function—
shall store the communication for later delivery with following additional information included—
shall include a Payload IE with:
the Payload content type set to “FILEURL” as specified in subclause 15.2.13 of 3GPP TS 24.282; and
the URL of the file to be stored for the later delivery in the Payload data as specified in subclause 15.2.13 of 3GPP TS 24.282; and

The file can be stored in the temporary storage of the MCData server (200) or MCData content server. The URL of stored file for later delivery is updated accordingly.
may include a Metadata IE with the required file description information and file availability information;
if the communication is stored in step 1) above and to store the file in the temporary storage, shall generate a SIP 200 (OK) response as specified in 3GPP TS 24.229 with the following clarifications:
a) shall include an SDP answer in the SIP 200 (OK) response to the SDP offer in the incoming SIP INVITE request according to 3GPP TS 24.229 with the following clarifications:
i) shall include an “m=message” media-level section for the accepted MCData media stream consisting of:
A) shall include the IP address and port number of the participating MCData function, for the accepted media stream in the received SDP offer;
B) a protocol field value of “TCP/MSRP” or “TCP/TLS/MSRP” for TLS according to the received SDP offer;
C) a format list field set to
D) an “a=recvonly” attribute;
E) an “a-path” attribute containing its own MSRP URI;
F) set the content type as a=accept-types:application/vnd.3gpp.mcdata-signalling; and
G) set the a=setup attribute set to “passive”, according to IETF RFC 6135;
b) shall include the option tag “timer” in a Require header field;
c) shall include the Session-Expires header field according to rules and procedures of IETF RFC 4028, “UAS Behavior”. If no “refresher” parameter was included in the SIP INVITE request, the “refresher” parameter in the Session-Expires header field shall be set to “uas”;
d) shall include the following in the Contact header field:
i) the g.3gpp.mcdata.fd media feature tag;
ii) the g.3gpp.icsi-ref media feature tag containing the value of “urn:urn-7:3gpp-service.ims.icsi.mcdata.fd”; and
iii) an MCData session identity mapped to the MCData session identity provided in the Contact header field of the received SIP INVITE request from the controlling MCData function;
e) shall start the SIP Session timer according to rules and procedures of IETF RFC 4028;
f) shall include the warning text set to “232 Communication is stored for the later delivery” in a Warning header field as specified in subclause 4.9 of 3GPP TS 24.282;
g) shall interact with the media plane as specified in 3GPP TS 24.582 subclause 7.2.5.1 to receive the file from controlling MCData function and subclause 7.1.3.2 to receive the file content; and
h) shall send the SIP 200 (OK) response to the controlling MCData function according to 3GPP TS 24.229; and
shall generate and send an FD NOTIFICATION indicating deferral of the FD request as specified in subclause 12.2.2.X of 3GPP TS 24.282.

On receipt of an indication from the media plane of the successful download of the file for later delivery, the participating MCData function:
1) shall update the URL of the stored file for the later delivery in the Payload data.

Handling of received MSRP messages: Upon receiving an MSRP SEND request from the controlling MCData function, the terminating participating MCData function:
1. shall generate and send a MSRP 200 (OK) response for the received MSRP SEND request to the controlling MCData function, according to the rules and procedures of IETF RFC 4975; and
2. shall forward the received MSRP SEND request to the terminating MCData client according to the rules and procedures of IETF RFC 4975.

If the indication to store the received file for the later delivery is received from the signaling plane, the participating function shall store the received file and shall indicate to the signalling plane that the file download is completed as specified in 3GPP TS 24.282 subclause 10.2.5.3.4.

Upon receiving an error MSRP response from the terminating MCData client, the participating MCData function shall forward the error MSRP response to the originating MCData client according to the rules and procedures of IETF RFC 4975.

Terminating controlling MCData function procedures: The procedures in this subclause are executed upon:
receipt of a “SIP INVITE request for controlling MCData function for file distribution”; or
1) shall determine targeted group members for MCData communications by following the procedures in subclause 6.3.4 of 3GPP TS 24.282;
2) if the procedures in subclause 6.3.4 of 3GPP TS 24.282 result in no affiliated members found in the selected MCData group, shall return a SIP 403 (Forbidden) response with the warning text set to “198 no users are affiliated to this group” in a Warning header field as specified in subclause 4.9 of 3GPP TS 24.282, and skip the rest of the steps below; and
3) shall invite each group member determined in step h) above, to the group session, as specified in subclause 10.2.5.4.3 of 3GPP TS 24.282; and
4) shall interact with the media plane as specified in 3GPP TS 24.582 subclause 7.3.
Upon receiving a SIP 200 (OK) response for a SIP INVITE request as specified in subclause 10.2.5.4.3 and if the warning text set to “232 Communication is stored for the later delivery” in a Warning header field as specified in subclause 4.9 of 3GPP TS 24.282:
1) shall generate SIP 200 (OK) response to the SIP INVITE request according to 3GPP TS 24.229;
2) shall include the option tag “timer” in a Require header field;
3) shall include the Session-Expires header field and start supervising the SIP session according to rules and procedures of IETF RFC 4028, “UAS Behavior”. The “refresher” parameter in the Session-Expires header field shall be set to “uac”;
4) shall include a P-Asserted-Identity header field with the public service identity of the controlling MCData function;
5) shall include a SIP URI for the MCData session identity in the Contact header field identifying the MCData session at the controlling MCData function;
6) shall include the following in the Contact header field:
a) the g.3gpp.mcdata.fd media feature tag;
b) the g.3gpp.icsi-ref media feature tag containing the value of “urn:urn-7:3gpp-service.ims.icsi.mcdata.fd”; and
c) the is focus media feature tag;
7) shall include Warning header field(s) received in incoming responses to the SIP INVITE request;
8) shall include in the SIP 200 (OK) response an SDP answer to the SDP offer in the incoming SIP INVITE request as specified in the subclause 10.2.5.4.2 of 3GPP TS 24.282;
8A) if the SIP INVITE request contains an alert indication set to a value of “true” and this is an unauthorised request for an MCData emergency alert as specified in subclause 6.3.7.2.1 of 3GPP TS 24.282, shall include in the SIP 200 (OK) response the warning text set to “149 SIP INFO request pending” in a Warning header field as specified in subclause 4.9 of 3GPP TS 24.282;
8B) if the received SIP INVITE request contains an application/vnd.3gpp.mcdata-info+xml MIME body with the <imminentperil-ind> element set to a value of “true” and if the in-progress emergency state of the group is set to a value of “true”, shall include in the SIP 200 (OK) response the warning text set to “149 SIP INFO request pending” in a Warning header field as specified in subclause 4.9 of 3GPP TS 24.282;
9) shall interact with the media plane as specified in 3GPP TS 24.582 subclause 7.3; and
10) shall send a SIP 200 (OK) response to the inviting MCData client according to 3GPP TS 24.229.

The controlling MCData function stores the INVITE session information that is established between the participating function and the controlling function for the later delivery to release the associated media plane resources and tear down of the MCData session when requested.

As shown in the FIG. 5, at 501, the first MCData client (100a) initiates the FD request. At 502, the first MCData client (100a) sends the MCData FD request along with the non-mandatory file download to the MCData server (200). At 503, the MCData server (200) authorizes the request. At 504, the MCData server (200) sends the MCData functional alias resolution response to the first MCData client (100a). At 505, the first MCData client (100a) sends the MCData FD request along with the non-mandatory file download to the MCData server (200). At 506, the MCData server (200) performs the transmission/reception control. At 507, the user not available or network congestion stores the FD request for later delivery.

At 508, MCData server (200) sends the MCData FD response to the first MCData client (100a). At 509, the first MCData client (100a) sends the file distribution over media plane to the MCData server (200). At 510, the MCData server (200) stores the file for later delivery. At 511, the second MCData client (100b) sends the deferred FD list request to the MCData server (200). At 512, the MCData server (200) sends the deferred FD list response to the second MCData client (100b). At 513, the second MCData client (100b) sends the download file request to the MCData server (200). At 514, the MCData server (200) sends the download file response to the second MCData client (100b).

As shown in the FIG. 6, at 601, the first MCData client (100a) initiates the FD request. At 602, the first MCData client (100a) sends the MCData FD request along with the non-mandatory file download to the MCData server (200). At 603, the MCData server (200) authorizes the request. At 604, the MCData server (200) sends the MCData functional alias resolution response to the first MCData client (100a). At 605, the first MCData client (100a) sends the MCData FD request along with the non-mandatory file download to the MCData server (200). At 606, the MCData server (200) performs the transmission/reception control. At 607, the MCData server (200) sends the MCData FD request along with the non-mandatory file download to the second MCData client (100b). At 608, the second MCData client (100b) notifies the request and waits for the user acceptance. At 609, the second MCData client (100b) sends the MCData FD response (including the Deferred) to the MCData server (200). At 610, the MCData server (200) sends the MCData FD response to the first MCData client (100a). At 611, the first MCData client (100a) sends the file distribution over media plane to the MCData server (200). At 612, the MCData server (200) stores the file for later delivery. At 613, the second MCData client (100b) sends the deferred FD list request to the MCData server (200). At 614, the MCData server (200) sends the deferred FD list response to the second MCData client (100b). At 615, the second MCData client (100b) sends the download file request to the MCData server (200). At 616, the MCData server (200) sends the download file response to the second MCData client (100b).

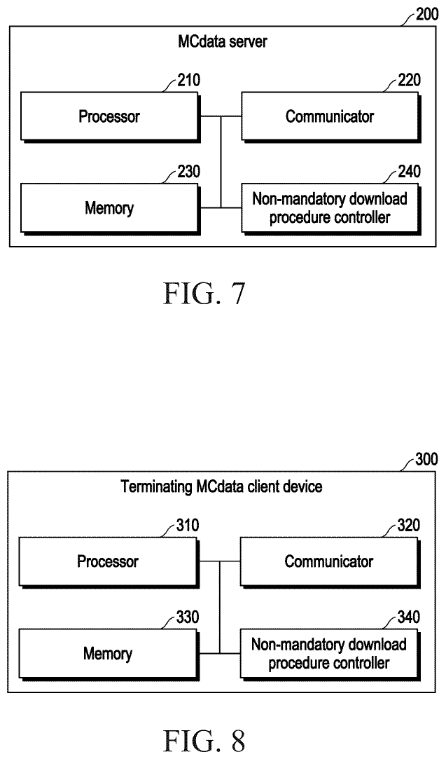

FIG. 7 shows various hardware components of the MCData server (200), according to the embodiments as disclosed herein. In an embodiment, the MCData server (200) includes a processor (210), a communicator (220), a memory (230) and a non-mandatory download procedure controller (240). The processor (210) is coupled with the communicator (220), the memory (230) and the non-mandatory download procedure controller (240).

The non-mandatory download procedure controller (240) receives the MCData FD request comprising the non-mandatory download indication for the file download from the originating MCData client device (100). Further, the non-mandatory download procedure controller (240) determines whether at least one of auto-receive configuration is enabled for the file download at the MCData server (200) and the file download criteria is met.

In an embodiment, the non-mandatory download procedure controller (240) receives the user consent for the file download from at least one terminating MCData client device of the plurality of the terminating MCData client devices (300) and sends the MCData FD response to the originating MCData client device (100) based on the received user consent from the at least one terminating MCData client device in response to determining that the auto-receive configuration is not enabled and the file download criteria is met. The user consent indicates one of MCData user accepted the request for the file download. The MCData user declined the request for the file download and the MCData user deferred the request for the file download.

In another embodiment, the non-mandatory download procedure controller (240) sends the MCData FD request comprising the non-mandatory download indication for the file download to the at least one terminating MCData client device of the plurality of the terminating MCData client devices (300), and receives a MCData FD response comprising the user consent from the at least one terminating MCData client device of the plurality of the terminating MCData client devices (300).

In an embodiment, the non-mandatory download procedure controller (240) sends the MCData FD request comprising the non-mandatory download indication for the file download to the at least one terminating MCData client device of the plurality of the terminating MCData client devices (300). Further, the non-mandatory download procedure controller (240) receives the MCData FD response from the at least one terminating MCData client device of the plurality of the terminating MCData client devices (300). Further, the non-mandatory download procedure controller (240) receives the FD disposition notification comprising the user consent from the at least one terminating MCData client device of the plurality of the terminating MCData client devices (200).

In an embodiment, the non-mandatory download procedure controller (240) converts the non-mandatory download indication to a mandatory download indication and sends the MCData FD request comprising the mandatory download to at least one terminating MCData client device of the plurality of the terminating MCData client devices (300). Further, the non-mandatory download procedure controller (240) sends a MCData FD response to the originating MCData client device (100) based on the received user consent from the at least one terminating MCData client device in response to determining that the auto-receive configuration is enabled and the file download criteria is met. The user consent indicates MCData user accepted the request for the file download.

In an embodiment, the non-mandatory download procedure controller (240) sends a MCData FD response to the originating MCData client device (100), receives the file distributed over the media plane from the originating MCData client device (100), and stores the file for later deliver as the file download criteria for at least one terminating MCData client device of the plurality of at least one terminating MCData client devices (300) is not met in response to determining that the file download criteria is not met irrespective of the auto-receive configuration is enabled or disabled.

In an embodiment, the MCData FD response is sent to the originating MCData client device (100) by sending the MCData FD response comprising the received user consent from the at least one terminating MCData client device to the originating MCData client device (100). In another embodiment, the MCData FD response is sent to the originating MCData client device (100) by determining that the received consent indicates that the MCData user of the at least one terminating MCData client device of the plurality of terminating MCData client devices (100) accepts the request for the file download, sending the MCData FD response indicating that the MCData user of the at least one terminating MCData client device of the plurality of terminating MCData client devices (300) accepts the request for the file download, and sending a FD disposition notification to the originating MCData client device (100). The FD disposition notification includes information about the at least one terminating MCData client device of the plurality of terminating MCData client devices (300) and the corresponding received consent for the file download.

Further, the non-mandatory download procedure controller (240) receives the file distributed over the media plane from the originating MCData client device (100). Further, the non-mandatory download procedure controller (240) determines the terminating MCData client devices of the plurality of MCData client devices (200) for which the received user consent indicates that MCData user accepted the request for the file download. Further, the non-mandatory download procedure controller (240) sends the file distributed over the media plane to the terminating MCData client devices (300) for which the received user consent indicates that MCData user accepted the request for the file download.

Further, the non-mandatory download procedure controller (240) receives the MCData download completed report from the at least one terminating MCData client device. Further, the non-mandatory download procedure controller (240) sends the MCData download completed report to the originating MCData client device (100).

Further, the non-mandatory download procedure controller (240) receives the file distributed over the media plane from the originating MCData client device (100). Further, the non-mandatory download procedure controller (240) determines the terminating MCData client devices of the plurality of MCData client devices (100) for which the received user consent indicates that MCData user deferred the request for the file download. Further, the non-mandatory download procedure controller (240) stores the file for later deliver for the terminating MCData client devices for which the received user consent indicates that MCData user deferred the request for the file download. Further, the non-mandatory download procedure controller (240) receives the deferred FD list request from the terminating MCData client devices. Further, the non-mandatory download procedure controller (240) sends the deferred FD list response to the terminating MCData client devices. Further, the non-mandatory download procedure controller (240) receives the file download request from the terminating MCData client devices. Further, the non-mandatory download procedure controller (240) sends the file download response to the terminating MCData client devices.

The non-mandatory download procedure controller (240) is physically implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (210) is configured to execute instructions stored in the memory (230) and to perform various processes. The communicator (220) is configured for communicating internally between internal hardware components and with external devices via one or more networks. The memory (230) also stores instructions to be executed by the processor (210). The memory (230) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (230) may, in some examples, be considered a non-transitory storage medium. The term “non-transitory” may indicate that the storage medium is not embodied in a carrier wave or a propagated signal. However, the term “non-transitory” should not be interpreted that the memory (230) is non-movable. In certain examples, a non-transitory storage medium may store data that can, over time, change (e.g., in Random Access Memory (RAM) or cache).

Although the FIG. 7 shows various hardware components of the MCData server (200) but it is to be understood that other embodiments are not limited thereon. In other embodiments, the MCData server (200) may include less or more number of components. Further, the labels or names of the components are used only for illustrative purpose and does not limit the scope of the invention. One or more components can be combined together to perform same or substantially similar function in the MCData server (200).

FIG. 8 shows various hardware components of the terminating MCData client device (300), according to the embodiments as disclosed herein. In an embodiment, the terminating MCData client device (300) includes a processor (310), a communicator (320), a memory (330) and a non-mandatory download procedure controller (340). The processor (310) is coupled with the communicator (320), the memory (330) and the non-mandatory download procedure controller (340).

The non-mandatory download procedure controller (340) receives the MCData FD request comprising the non-mandatory download indication for file download from the MCData server (200). Further, the non-mandatory download procedure controller (340) generates the user consent for the file download. The user consent indicates one of MCData user accepted the request for the file download, the MCData user declined the request for the file download, and the MCData user deferred the request for the file download. In an embodiment, the non-mandatory download procedure controller (340) sends the MCData FD response comprising the user consent to the MCData server (200). In another embodiment, the non-mandatory download procedure controller (340) sends the MCData FD response to the MCData server (200) and sends the FD disposition notification comprising the user consent to the MCData server (200).

Further, the non-mandatory download procedure controller (240) receives file distributed over the media plane from the MCData server (200) and sends a download completed report to the MCData server (200).

Further, the non-mandatory download procedure controller (240) sends a deferred FD list request to the MCData server (200) and receives a deferred FD list response from the MCData server (200). Further, the non-mandatory download procedure controller (240) sends the file download request to the MCData server (200) and receives a file download response from the MCData server (200).

The non-mandatory download procedure controller (340) is physically implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (310) is configured to execute instructions stored in the memory (330) and to perform various processes. The communicator (320) is configured for communicating internally between internal hardware components and with external devices via one or more networks. The memory (330) also stores instructions to be executed by the processor (310). The memory (330) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (330) may, in some examples, be considered a non-transitory storage medium. The term “non-transitory” may indicate that the storage medium is not embodied in a carrier wave or a propagated signal. However, the term “non-transitory” should not be interpreted that the memory (330) is non-movable. In certain examples, a non-transitory storage medium may store data that can, over time, change (e.g., in Random Access Memory (RAM) or cache).

Although the FIG. 8 shows various hardware components of the terminating MCData client device (300) but it is to be understood that other embodiments are not limited thereon. In other embodiments, the terminating MCData client device (300) may include less or more number of components. Further, the labels or names of the components are used only for illustrative purpose and does not limit the scope of the invention. One or more components can be combined together to perform same or substantially similar function in the terminating MCData client device (300).

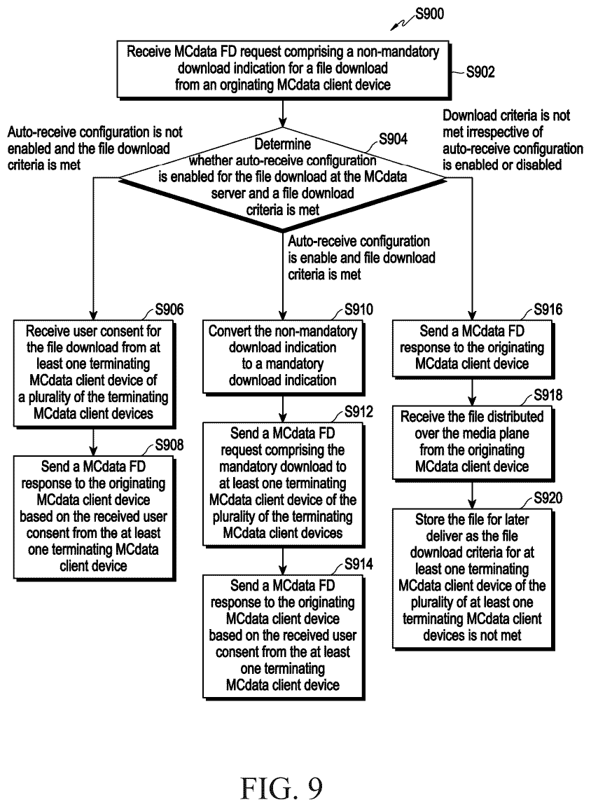

FIG. 9 is a flow chart (S900) illustrating a method, implemented by the MCData server (200), for handling non-mandatory download procedure for the FD over the media plane in the MCData network (1000), according to the embodiments as disclosed herein. The operations (S902-S920) are handled by the non-mandatory download procedure controller (240).

At S902, the method includes receiving the MCData FD request comprising the non-mandatory download indication for the file download from the originating MCData client device (100). At S904, the method includes determining whether at least one of auto-receive configuration is enabled for the file download at the MCData server (200) and the file download criteria is met. In response to determining that the auto-receive configuration is not enabled and the file download criteria is met, at S906, the method includes receiving the user consent for the file download from at least one terminating MCData client device of a plurality of the terminating MCData client devices (300). At S908, the method includes sending the MCData FD response to the originating MCData client device (100) based on the received user consent from the at least one terminating MCData client device.

In response to determining that the auto-receive configuration is enabled and the file download criteria is met, at S910, the method includes converting the non-mandatory download indication to a mandatory download indication. At S912, the method includes sending the MCData FD request comprising the mandatory download to at least one terminating MCData client device of the plurality of the terminating MCData client devices (300). At S914, the method includes sending a MCData FD response to the originating MCData client device (100) based on the received user consent from the at least one terminating MCData client device.

In response to determining that the file download criteria is not met irrespective of the auto-receive configuration is enabled or disabled, at S916, the method includes sending a MCData FD response to the originating MCData client device (100). At S918, the method includes receiving the file distributed over the media plane from the originating MCData client device (100). At S920, the method includes storing the file for later deliver as the file download criteria for at least one terminating MCData client device of the plurality of at least one terminating MCData client devices (300) is not met.

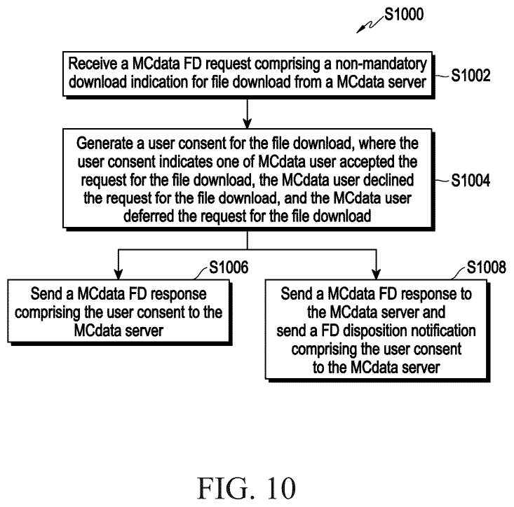

FIG. 10 is a flow chart (S1000) illustrating a method, implemented by the terminating MCData client device (300), for handling non-mandatory download procedure for the FD over the media plane in the MCData network (1000), according to the embodiments as disclosed herein. The operations (S1002-S1020) are handled by the non-mandatory download procedure controller (340).

At S1002, the method includes receiving the MCData FD request comprising the non-mandatory download indication for file download from the MCData server (200). At S1004, the method includes generating the user consent for the file download. The user consent indicates one of MCData user accepted the request for the file download, the MCData user declined the request for the file download, and the MCData user deferred the request for the file download. At S1006, the method includes sending the MCData FD response comprising the user consent to the MCData server (200). At S1008, the method includes sending the MCData FD response to the MCData server (200) and sending the FD disposition notification comprising the user consent to the MCData server (200).

The various actions, acts, blocks, steps, or the like in the flow charts (S900 and S1000) may be performed in the order presented, in a different order or simultaneously. Further, in some embodiments, some of the actions, acts, blocks, steps, or the like may be omitted, added, modified, skipped, or the like without departing from the scope of the invention.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

1. A method for handling non-mandatory download procedure for file distribution (FD) over a media plane by a mission critical data (MCData) client, the method comprising:
receiving a SIP INVITE request including a FD signaling payload message without a mandatory download IE;
notifying about a FD request and waiting for a response of a MCData user, wherein the response of the MCData user is an accept for the FD request, a reject for the FD request, or defer for the FD request; and
transmitting, to a MCData server, a SIP response based on the response of the MCData user.

2. The method of claim 1, wherein the transmitting the SIP response comprises:
based on the response of the MCData user being the reject for the FD request, transmitting, to the MCData server, the SIP response with a warning text set to a user declined call invitation in a warning header field.

3. The method of claim 1, wherein the transmitting the SIP response comprises:
based on the response of the MCData user being the defer for the FD request, transmitting, to the MCData server, the SIP response with a warning text set to a user deferred call invitation in a warning header field.

4. The method of claim 1, wherein the transmitting the SIP response comprises:
based on the response of the MCData user being the accept for the FD request, transmitting, to the MCData server, the SIP response,
wherein the SIP response includes at least one of a timer tag in a require header field, a refresher parameter in a session-expires header field, a media feature tag in a contact header field, a session description protocol (SDP) answer.

5. The method of claim 4, wherein the media feature tag is g.3gpp.mcdata.fd media feature tag in the Contact header field.

6. The method of claim 4, wherein the media feature tag is g.3gpp.icsi-ref media feature tag containing a value of urn:urn-7:3gpp-service.ims.icsi.mcdata.fd in the contact header field.

7. The method of claim 4, further comprising:
storing a conversation ID, a message ID, an InReplyTo message ID, and date and time in local storage.

8. The method of claim 1, wherein the SIP response comprises a warning text in a warning header field, wherein the warning text is a first code, a second code, or a third code,
wherein the first code indicates that the MCData user has declined to accept a call for the FD,
wherein the second code indicates that the MCData user has deferred a call invitation for FD, and
wherein the third code indicates that a participating MCData function stores a communication for later delivery if the MCData user is not available at time of data delivery or a network is congested, or the FD request is deferred by the MCData user.

9. A mission critical data (MCData) client for handling non-mandatory download procedure for file distribution (FD) over a media plane in a MCData network, wherein the MCData client comprises:
a memory;
a processor; and
a non-mandatory download procedure controller, communicatively coupled to the memory and the processor, configured to:
receive a SIP INVITE request including a FD signaling payload message without a mandatory download IE,
notify about a FD request and wait for a response of a MCData user, wherein the response of the MCData user is an accept for the FD request, a reject for the FD request, or defer for the FD request, and
transmit, to a MCData server, a SIP response based on the response of the MCData user.

10. The MCData client of claim 9, wherein the non-mandatory download procedure controller is configured to:
based on the response of the MCData user being the reject for the FD request, transmit, to the MCData server, the SIP response with a warning text set to a user declined call invitation in a warning header field.

11. The MCData client of claim 9, wherein the non-mandatory download procedure controller is configured to:
based on the response of the MCData user being the defer for the FD request, transmit, to the MCData server, the SIP response with a warning text set to a user deferred call invitation in a warning header field.

12. The MCData client of claim 9, wherein the non-mandatory download procedure controller is configured to:
based on the response of the MCData user being the accept for the FD request, transmit, to the MCData server, the SIP response,
wherein the SIP response includes at least one of a timer tag in a require header field, a refresher parameter in a session-expires header field, a media feature tag in a contact header field, a session description protocol (SDP) answer.

13. The MCData client of claim 12, wherein the media feature tag is g.3gpp.mcdata.fd media feature tag in the Contact header field.

14. The MCData client of claim 12, wherein the media feature tag is g.3gpp.icsi-ref media feature tag containing a value of urn:urn-7:3gpp-service.ims.icsi.mcdata.fd in the contact header field.

15. The MCData client of claim 12, further comprising:
storing a conversation ID, a message ID, an InReplyTo message ID, and date and time in local storage.

16. The MCData client of claim 9,
wherein the SIP response comprises a warning text in a warning header field, wherein the warning text is a first code, a second code, or a third code,
wherein the first code indicates that the MCData user has declined to accept a call for the FD,
wherein the second code indicates that the MCData user has deferred a call invitation for FD, and
wherein the third code indicates that a participating MCData function stores a communication for later delivery if the MCData user is not available at time of data delivery or a network is congested, or the FD request is deferred by the MCData user.
